(19) United States
(12) Patent Application Publication
(10) Pub. No.: US 2025/0196499 A1
(43) Pub. Date: Jun. 19, 2025

(54) LIQUID DISCHARGE HEAD, MANUFACTURING METHOD OF LIQUID DISCHARGE HEAD

(71) Applicant: CANON KABUSHIKI KAISHA, Tokyo (JP)

(72) Inventor: HIROSHI HIGUCHI, Kanagawa (JP)

(21) Appl. No.: 18/964,796

(22) Filed: Dec. 2, 2024

(30) Foreign Application Priority Data
Dec. 14, 2023 (JP) 2023-210990
Sep. 26, 2024 (JP) 2024-167211

(51) Int. Cl. B41J 2/14; B41J 2/16

(52) U.S. Cl. CPC B41J 2/14233; B41J 2/161; B41J 2/1623; B41J 2/164; B41J 2002/14306

(57) ABSTRACT

A liquid discharge head includes a nozzle from which a liquid is discharged, pressure generator that generates a pressure for discharging the liquid from the nozzle, a pressure chamber in which the pressure generator is formed inside, a liquid flow-passage that communicates with the nozzle, a space formed adjacently to the liquid flow-passage and separated from the liquid flow-passage, a base body constituting a wall part forming the liquid flow-passage and a wall part forming the space, and a flexible member made of a resin, fixed to the base body, separating the fluid flow-pressure and the space, and warped in accordance with pressure fluctuation generated in the pressure chamber. An inorganic film is provided on a surface of the flexible member.

### BACKGROUND

### Field

The present disclosure relates to a liquid discharge head and a manufacturing method thereof.

### Description of the Related Art

In a liquid discharge head which generates pressure fluctuation in a pressure generation chamber filled with a liquid and discharges the liquid from a nozzle, for the purpose of avoiding propagation of the pressure fluctuation to another adjacent pressure generation chamber and causing deterioration of discharge controllability, such a head configuration is known that a unit member called a damper for suppressing the pressure fluctuation is disposed in a liquid flow-passage. Japanese Patent No. 7131260 discloses such a configuration that, in a configuration in which the damper is joined to a substrate by using an adhesive, prevents adhesion of the protruding adhesive to the damper by disposing the member on a joint portion and suppresses variation in a fluctuation suppressing effect.

### SUMMARY OF THE DISCLOSURE

When the damper is to be joined to the substrate by using an adhesive, heat treatment for hardening the adhesive is needed. At this heat treatment, due to a difference in linear expansion between the damper and a peripheral member such as the substrate, the damper is warped (curved) to an adjacent fluctuation-suppressing space side in some cases. When the damper is joined to the substrate in the warped state, a deformation amount of the damper is limited at generation of the pressure fluctuation and thus, the fluctuation-suppressing effect itself is lowered, a damper performance is not sufficiently exerted, and there is a concern that the discharge controllability is deteriorated.

In order to solve the aforementioned problem, the present disclosure has an object to provide a liquid discharge head that suppresses deterioration of the discharge controllability.

In order to achieve the object described above, a liquid discharge head according to the present disclosure includes:
a nozzle from which a liquid is discharged;
pressure generator that generates a pressure for discharging the liquid from the nozzle;
a pressure chamber in which the pressure generator is formed inside;
a liquid flow-passage that communicates with the nozzle;
a space formed adjacently to the liquid flow-passage and separated from the liquid flow-passage;
a base body constituting a wall part forming the liquid flow-passage and a wall part constituting the space; and
a flexible member made of a resin, fixed to the base body, and separating the liquid flow-passage and the space, the flexible member being warped in accordance with pressure fluctuation generated in the pressure chamber, and an inorganic film being provided on a surface of the flexible member.

Furthermore, in order to achieve the object described above, manufacturing method of a liquid discharge head, the liquid discharge head including a nozzle from which a liquid is discharged, pressure generator that generates a pressure for discharging the liquid from the nozzle, a pressure chamber in which the pressure generator is formed inside, a liquid flow-passage communicating with the nozzle, a space formed adjacently to the liquid flow-passage and separated from the liquid flow-passage, a base body constituting a wall part forming the liquid flow-passage and a wall part forming the space, a flexible member made of a resin, which is fixed to the base body, separates the liquid flow-passage and the space from each other and is warped in accordance with pressure fluctuation generated in the pressure chamber, and an inorganic film provided on a surface of the flexible member, the manufacturing method includes:
a process of applying an adhesive on a surface of the base body;
a process of bonding the flexible member on the surface of the base body on which the adhesive was applied;
a process of executing heat treatment and hardening the adhesive; and
a process of forming the inorganic film on the surface of the flexible member.

According to the present disclosure, a liquid discharge head that suppresses deterioration of the discharge controllability can be provided.

Further features of the present disclosure will become apparent from the following description of exemplary embodiments with reference to the attached drawings.

### BRIEF DESCRIPTION OF THE DRAWINGS

FIG. 1 is a schematic sectional diagram of a substrate for liquid discharge head;

FIG. 2 is an exploded perspective view of the substrate for liquid discharge head;

FIGS. 3A to 3D are explanatory diagrams of a manufacturing method of a compliance substrate according to a Comparative Example;

FIGS. 4A to 4E are explanatory diagrams of a manufacturing method of a compliance substrate according to a First Embodiment;

FIG. 5 is a schematic sectional diagram of a compliance substrate according to a Second Embodiment;

FIG. 6 is a schematic sectional diagram of a compliance substrate according to a Third Embodiment;

FIGS. 7A and 7B are explanatory diagrams of a compliance substrate according to a Fourth Embodiment;

FIGS. 8A and 8B are explanatory diagrams of a compliance substrate according to a Fifth Embodiment;

FIGS. 9A and 9B are explanatory diagrams of a compliance substrate according to a Sixth Embodiment;

FIGS. 10A to 10F are explanatory diagrams of a manufacturing method of a compliance substrate according to a Seventh Embodiment;

FIG. 11 is a schematic sectional diagram of a substrate for liquid discharge head according to an Example 1;

FIG. 12 is a schematic sectional diagram of a substrate for liquid discharge head according to a Comparative Example;

FIG. 13 is a schematic sectional diagram of a substrate for liquid discharge head according to an Example 2;

FIG. 14 is a schematic sectional diagram of a substrate for liquid discharge head according to an Example 3;

FIGS. 15A to 15E are explanatory diagrams of a manufacturing method of a substrate for liquid discharge head according to an Eighth Embodiment;

FIG. 16 is a schematic sectional diagram of a substrate for liquid discharge head according to a Ninth Embodiment;

FIG. 17 is a schematic sectional diagram of a substrate for liquid discharge head according to an Example 4; and

FIG. 18 is a schematic perspective view illustrating an example of a liquid discharge head.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

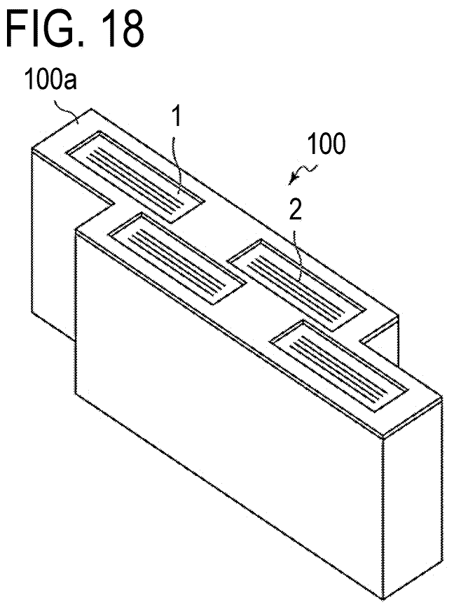

FIG. 18 is a schematic perspective view for explaining an example of a liquid discharge head to which the present disclosure can be applied. In the liquid discharge head 100, a plurality of substrates 1 for liquid discharge head having a nozzle 2 at a liquid discharge head main-body 100a are disposed. Ink to be discharged is supplied to the substrate 1 for liquid discharge head from a liquid tank (not shown) via a common supply port (not shown) of the liquid discharge head main-body 100a.

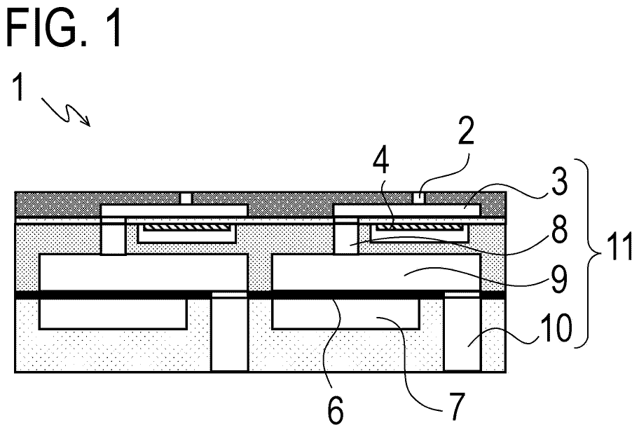

By using FIG. 1, a configuration of the substrate for liquid discharge head of the present disclosure and a manufacturing method thereof will be explained. FIG. 1 is a schematic sectional diagram of a substrate for liquid discharge head. In general, the substrate 1 for liquid discharge head constitutes a part of the liquid discharge head and is a substrate mainly bearing a function of distributing a liquid supplied mainly from an outside to each of the individual nozzles and causing a liquid to be discharged from the plurality of nozzles (not shown). The substrate 1 for liquid discharge head to which the present disclosure is applied has the nozzle 2 that discharges the liquid and a liquid flow-passage 11 coupled to the nozzle 2. In FIG. 1, as a section of the substrate 1 for liquid discharge head, a section of an area in which two pieces of the nozzles 2 are disposed is illustrated.

The liquid flow-passage 11 is constituted by elements such as a pressure chamber 3 including pressure generator 4, an individual supply port 8, a common flow-passage 9, a liquid supply port 10 and the like, and disposition spots, dimensions, paths and the like thereof can take various constitutions in accordance with a manufacturing method or a required discharge performance. For example, it is possible to have such a path of the liquid flow-passage that a liquid supplied from outside the substrate for liquid discharge head is transported to the vicinity of the nozzle, and the liquid that has not been discharged is returned to the outside again can be acquired. In the middle of the liquid flow-passage 11, a flexible member 6 that suppresses pressure fluctuation is formed together with an adjacent space 7.

For the pressure generator 4, a vibrating plate in which piezoelectric elements are laminated, a heat element and the like can be used, for example. The pressure generator 4 is formed in the pressure chamber 3 and generates a pressure for discharging a liquid such as ink from the nozzle 2.

The individual supply port 8 is coupled to the pressure chamber 3, which is individually controlled, but there may be such a configuration that a plurality of the individual supply ports 8 are coupled to one unit of the pressure chamber 3 or to the contrary, a configuration that one unit of the individual supply port 8 is coupled to a plurality of the pressure chambers 3.

The common flow-passage 9 is connected to a plurality of the individual supply ports 8 and functions as a reservoir for distributing a liquid.

The flexible member 6 is provided in the middle of the liquid flow-passage 11, forms a part of a side wall of the liquid flow-passage 11 and is formed so as to contact the liquid. Adjacently to the flexible member 6, a space 7 to be a space for displacement is provided, and the liquid does not flow therein. The flexible member 6 has a part other than a fixed portion warped in accordance with the pressure fluctuation generated in the pressure chamber 3. The flexible member 6 is a member for absorbing the pressure fluctuation generated in the pressure chamber 3 by its flexibility, suppressing pressure propagation to the pressure chamber 3 in the vicinity and making a discharge performance stable. Such a configuration is possible for the space 7 that an atmospheric communication port is provided so that the inside is brought into a vacuum state, and displacement of the flexible member 6 is not limited.

For the flexible member 6, a film of various materials having flexibility such as an organic film, an inorganic film, a metal film and the like can be applied, but preferably, an organic resin film having both flexibility and resistance against a liquid is used. As the organic resin film that can be applied to the flexible member 6, polyimide, polyamide, polyphenylene sulfide and the like can be cited. A thickness of the flexible member 6 may be set appropriately with an elastic modulus as a reference by considering viscosity and density of the liquid suppressing the pressure fluctuation, a discharge frequency of the liquid, a distance to the pressure chamber 3 and the like. In general, for an application as the substrate 1 for liquid discharge head, the thickness of the flexible member 6 is formed within a range from submicron to approximately several tens of microns.

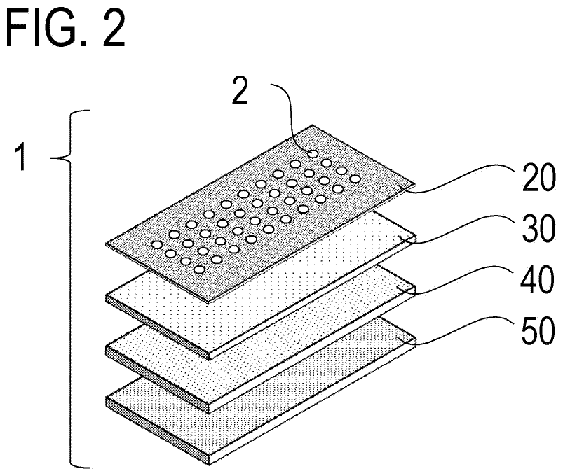

With reference to FIG. 2, a manufacturing method of the substrate 1 for liquid discharge head will be explained. FIG. 2 is an exploded perspective view of the substrate 1 for liquid discharge head. As shown in FIG. 2, the substrate 1 for liquid discharge head is manufactured by joining a plurality of substrates via an adhesive. The substrate constituting the substrate 1 for liquid discharge head includes, for example, a nozzle substrate 20, a pressure-generation substrate 30, a flow-passage substrate 40, and a compliance substrate 50. FIG. 2 illustrates the substrate 1 for liquid discharge head having the nozzle substrate 20, the pressure-generation substrate 30, the flow-passage substrate 40, and the compliance substrate 50 in this order, that is, the substrate 1 for liquid discharge head constituted by these substrates aligned in this order. Unless otherwise noted, the substrate 1 for liquid discharge head in each of the Embodiments and each of the examples which will be explained below has the constitution as above.

Subsequently, a constitution and a manufacturing method of the compliance substrate 50, which is a constituent element of the substrate 1 for liquid discharge head, will be explained separately for a Comparative Example and a plurality of Embodiments according to the present disclosure. First, the Comparative Example will be explained and then, First to Ninth Embodiments will be explained. In the explanation of the constitution of each of the Embodiments, the same signs are given to the constitutions similar to the previously explained Embodiments, and the explanation will be omitted.

### Comparative Example

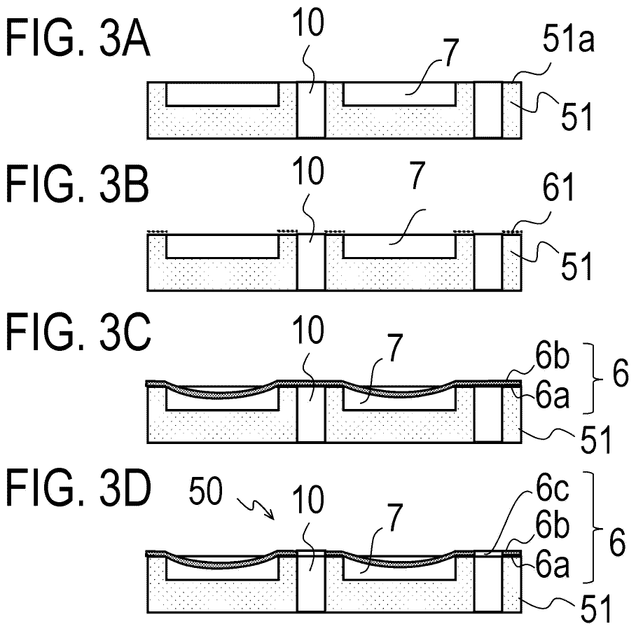

With reference to FIGS. 3A to 3D, a manufacturing method of the compliance substrate 50 according to the Comparative Example will be explained. FIGS. 3A to 3D are explanatory diagrams of the manufacturing method of the compliance substrate 50 according to the Comparative Example. In FIGS. 3A to 3D and the drawings which will be explained below, a state in which two each of the spaces 7 and the liquid supply ports 10 are provided is illustrated, but the number and the size of the various constituent elements are not limited to those illustrated. The compliance substrate 50 is a composite substrate of a base substrate 51 in which the space 7, the liquid supply port 10 and the like are machined and the flexible member 6 and is manufactured by bonding the flexible member 6 on the base substrate 51 as a base body and then fixing them.

FIG. 3A illustrates a state in which a plurality of the spaces 7 and the liquid supply ports 10 are formed in the base substrate 51. For the base substrate 51, a silicon substrate, for example, is used. On the base substrate 51, the space 7 and the liquid supply port 10 are formed in the base substrate 51 by machining methods such as chemical machining as etching and laser machining and the like. In other words, the base substrate 51 functions as a flow-passage forming member and a space forming member constituting a wall part of the liquid flow-passage 11 (the common flow passage 9 and the liquid supply port 10) and the space 7. The space 7 is formed so as to be opened in an adhesive surface 51a of the base substrate 51 on which an adhesive 61, which will be described later, is applied. The adhesive surface 51a is a fixing surface for fixing the flexible member 6. The liquid supply port 10 is formed by penetrating the base substrate 51 from the adhesive surface 51a to the surface opposite to the adhesive surface 51a.

FIG. 3B illustrates a state in which the adhesive 61 is applied on the base substrate 51. On the adhesive surface 51a of the machined base substrate 51, the adhesive 61 for fixing the flexible member 6 is applied.

FIG. 3C illustrates a state in which the flexible member 6 is fixed on the base substrate 51. In the explanation below, a fixed surface (an adhering surface) fixed to the adhesive surface 51a of the base substrate 51 of the flexible member 6 is explained as a first surface 6a, and a surface on the side opposite to the first surface 6a as a second surface 6b. In a state in which the compliance substrate 50 adheres to the flow-passage substrate 40, and the substrate 1 for liquid discharge head is completed, the first surface 6a faces the space 7 side, while the second surface 6b faces the common flow-passage 9 side (liquid flow-passage 11 side).

After the application of the adhesive 61 on the base substrate 51, then, the film-state flexible member 6 is bonded onto the base substrate 51 by roller pressurization or the like. After that, the heat treatment (curing) is performed so as to harden the adhesive 61 and to fix the flexible member 6 to the base substrate 51. A temperature of the heat treatment differs in accordance with the material of the adhesive or a heat-resistant temperature of the flexible member 6, but polymerization of adhesive molecules is promoted by heating at several hundred degrees, for example, for hardening. Through the fixing process of the flexible member 6, the space 7 becomes a space surrounded and closed by the flexible member 6 and the base substrate 51. In addition, an opening on the adhesive surface 51a side of the liquid supply port 10 is closed by the flexible member 6.

FIG. 3D illustrates a state in which an opening portion 6c is formed in the flexible member 6. After the flexible member 6 is fixed onto the base substrate 51, the opening portion 6c, which becomes a passage for the liquid, is formed in the flexible member 6. The opening portion 6c is formed at a position to be connected to the liquid supply port 10. That is, when viewed in a direction perpendicular to the adhesive surface 51a, the opening portion 6c is formed at the position overlapping the liquid supply port 10. The opening portion 6c is formed by performing etching after a pattern is formed by a photolithography method, for example.

In the compliance substrate 50 manufactured as above, there is such a case that the flexible member 6 is formed in a warped state so as to be convex toward the space 7 side. FIG. 3C illustrates a state in which the flexible member 6 fixed onto the base substrate 51 is warped. The warping of the flexible member 6 occurs mainly at the curing and is considered to be caused by internal stress due to a microscopic structure or the like of each constituent element and heat stress due to a heat expansion coefficient of each constituent element. More specifically, a difference in the heat expansion between the flexible member 6 and the base substrate 51 to be a base is considered to be a cause. That is, when the flexible member 6 and the base substrate 51 thermally expands by the curing, one surface of the flexible member 6 is fixed to the base substrate 51 in that state and cooled after that, a difference in a contraction amount is generated between the surface of the flexible member 6 fixed to the base substrate 51 and the surface that is not fixed. Then, stress is generated in the flexible member 6, and the stress is considered to become one cause of the generation of warping.

In a laminated body of different kinds of materials, whose heat expansion coefficients are different, stress causing a curve so as to become convex toward a side of the material whose heat expansion coefficient is smaller is generated in general. Therefore, when a silicon substrate is used for the base substrate 51, and an organic resin for the flexible member 6, for example, there is a relation in the heat expansion coefficient as the heat expansion coefficient of the flexible member>the heat expansion coefficient of the silicon substrate in general. In such a case, the flexible member 6 is curved and warped so as to be convex toward the space 7 side. If the substrate 1 for liquid discharge head is fabricated in the state in which the flexible member 6 is warped as above, displacement of the flexible member 6 to the space 7 side is limited at the absorption of the pressure fluctuation, and the suppression function is also limited. Therefore, in the configuration of the Comparative Example, when the pressure fluctuation is generated in the common flow-passage 9 in the pressure generation chamber, there is a concern that the pressure fluctuation propagates to another common flow-passage 9 or the like and discharge controllability of the substrate 1 for liquid discharge head is deteriorated.

### First Embodiment

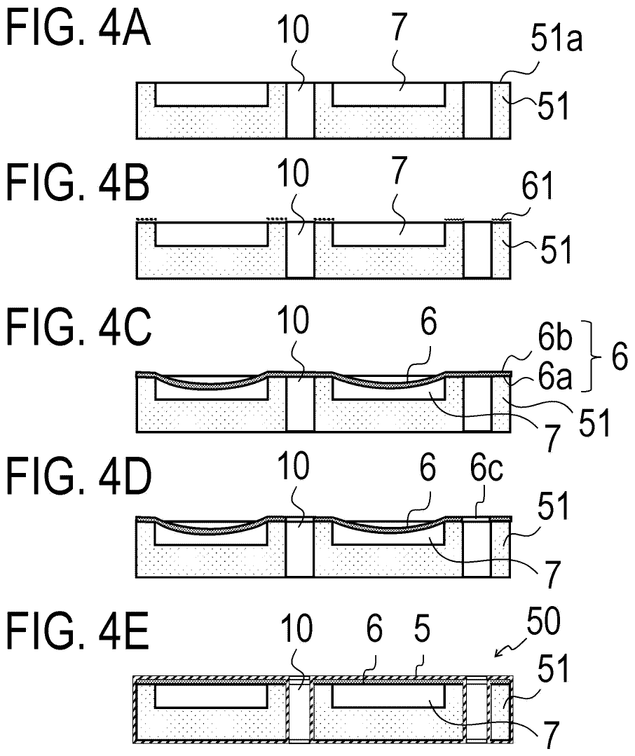

Subsequently, with reference to FIGS. 4A to 4E, the compliance substrate 50 according to the First Embodiment will be explained. FIGS. 4A to 4E are explanatory diagrams of the manufacturing method of the compliance substrate 50 according to the First Embodiment. In the First Embodiment, a surface member 5 is formed on the flexible member 6 of the compliance substrate 50. For the surface member 5, any material such as an organic material, an inorganic material, a metal material and the like can be applied. However, in the case of the material such as the inorganic material which would hinder flexibility of the flexible member 6 depending on the thickness, it is preferable that the film thickness is thinned as much as possible within a range that can alleviate the warping so as to have a thin film which would not hinder the flexibility, or it is more preferably approximately submicron. The configuration disclosed in Japanese Patent No. 7131260 is such a configuration that members which are thick and do not have the flexibility (or the flexibility is extremely small) are laminated in order to prevent protruding of an adhesive onto the flexible film. It is fundamentally different from the substrate 1 for liquid discharge head according to the First Embodiment having the film-state member which moves by following the flexible member.

FIGS. 4A to 4E illustrate the manufacturing method of the compliance substrate 50 according to the First Embodiment. FIG. 4A illustrates a state in which the space 7 and the liquid supply port 10 are formed in the base substrate 51. FIG. 4B illustrates a state in which the adhesive 61 is applied on the base substrate 51. FIG. 4C illustrates a state in which the flexible member 6 is fixed onto the base substrate 51. FIG. 4D illustrates a state in which the opening portion 6c is formed in the flexible member 6. A manufacturing process shown in these diagrams are processes similar to those in FIGS. 3A to 3D according to the Comparative Example. As shown in FIGS. 4C and 4D, after a fixing process of the flexible member 6 to the base substrate 51 and before a forming process of the surface member 5, which will be described later, the flexible member 6 is fixed to the base substrate 51 in a state warped to the space 7 side.

FIG. 4E illustrates a state in which the surface member 5 is formed on a surface of the flexible member 6. The surface member 5 is a film-state member which reduces warping of the flexible member 6 so that such stress that causes curving to a direction opposite to the warping is generated in the flexible member 6. In the First Embodiment, the surface member 5 is formed on the surface of the flexible member 6 and on an inner peripheral surface of the liquid supply port 10 so as to cover the entire compliance substrate 50. More specifically, the surface member 5 is formed so as to cover exposed surfaces of the base substrate 51 and the flexible member 6 in the compliance substrate 50. That is, the surface member 5 is not formed on the first surface 6a facing the space 7 side of the flexible member 6 but is formed on the second surface 6b on the side opposite to the first surface 6a. By means of the formation of the surface member 5, the warping of the flexible member 6 to become convex on the space 7 side in the state in which the pressure generator 4 has not generated a pressure is reduced, and the flexible member 6 gets closer to a straight state. As described above, since the warping of the flexible member 6 in an unused state of the substrate 1 for liquid discharge head is reduced, lowering in the effect of absorbing the pressure fluctuation by the flexible member 6 is suppressed, and the deterioration of the discharge controllability of the substrate 1 for liquid discharge head is suppressed.

In order to reduce (correct) warping of the flexible member 6 warped toward the space 7 side, in the First Embodiment, a material with a heat expansion coefficient smaller than that of the flexible member 6 to be the base is used for the surface member 5. Internal stress of the thin film is different depending on a composition and a thickness and is also different depending on a film-forming method and a film-forming condition such as a pressure and the like and thus, it is preferable that the film-forming method, the film-forming condition and the like of the surface member are selected so that stress in an appropriate direction can be obtained. In general, in the case of the metal thin film, it is known that the sputter method, the ion-plating method and the like indicate compression stress, while deposition, the Chemical Vapor Deposition (CVD) method and the like indicate tensile stress.

As shown in FIG. 4E, when the surface member 5 is formed so as to cover the entire compliance substrate 50, the Atomic Layer Deposition (ALD) method or the like can be used. For example, it is preferable that an inorganic oxide thin-film indicating pressure stress with respect to the flexible member 6 to be the base is formed into a film with a thickness of approximately several hundred nm by the ALD method. In addition, it is preferable to use a material indicating flexibility such as an organic resin for the flexible member 6, and the heat expansion coefficient can be selected within a range from approximately several ppm to approximately several hundred ppm in general. Therefore, it is preferable that, for the surface member 5, a material having a heat expansion coefficient smaller than that of the flexible member 6 to be the base such as an inorganic thin film or a material with a heat expansion coefficient from approximately several ppm to approximately several ten ppm is used. Particularly, when the organic resin is used for the flexible member 6, it is desirable that an inorganic film is used for the surface member 5 from the viewpoint of the difference in the heat expansion coefficient.

As shown in FIG. 1, the flexible member 6 constitutes a part of the side wall of the liquid flow-passage 11. Therefore, since the surface member 5 is exposed to the liquid flow-passage 11 side, it is preferable that the surface member 5 has resistance against a liquid. Since the surface member 5 is not dissolved easily, the warping of the flexible member 6 can be suppressed for a long time. In addition, in the side wall of the liquid flow-passage 11, there is such a case that a protective film with resistance against a liquid is needed also for the part constituted by a member other than the flexible member 6. In such a case, by selecting the film-forming method capable of conformal film forming such as the ALD method, the CVD method and the like, a protective film can be also formed altogether not only on the surface of the flexible member 6 but also on the surface of the liquid flow-passage 11, by which the number of processes can be reduced. As a material having such resistance against solubility, tantalum oxide, titanium oxide, silicon carbide can be suitably used as the surface member 5, for example. In addition, a film having insulation such as silicon oxide, silicon nitride and the like can be also suitably used for the surface member 5.

### Second Embodiment

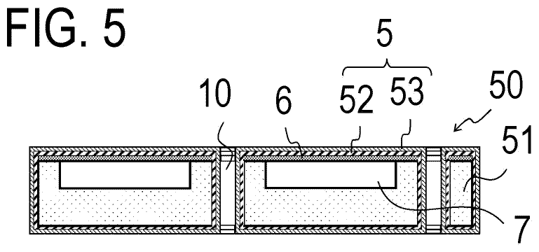

Subsequently, with reference to FIG. 5, the compliance substrate 50 according to a Second Embodiment will be explained. FIG. 5 is a schematic sectional diagram of the compliance substrate 50 according to the Second Embodiment. In the Second Embodiment, the surface member 5 formed on the surface of the flexible member 6 of the compliance substrate 50 is a laminated member constituted by a plurality of materials.

The surface member 5 according to the Second Embodiment is a film-state member constituted by a first surface layer 52 in contact with the flexible member 6 and a second surface layer 53 formed on the first surface layer 52 and in contact with the liquid in the liquid flow-passage 11. The first surface layer 52 is specialized in a function of reducing warping of the flexible member 6 by its internal stress and is a layer adjacent to the space 7. The second surface layer 53 is specialized in a protective film function, is a layer adjacent to the liquid flow-passage 11, and includes a component different from that of the first surface layer 52. As described above, by having the surface member 5 in a two-layer constitution, the function required for the surface member 5 can be controlled separately for each layer, and such a design to maximize an effect of the surface member 5 can be made. For example, by forming the first surface layer 52 by tantalum oxide and by forming the second surface layer 53 by silicon carbide, the function of reducing warping and the protective-film function of the surface member 5 can be maximized. As described above, by constituting the surface member 5 by a plurality of layers, deterioration in the discharge controllability of the substrate 1 for liquid discharge head can be suppressed more effectively.

Note that the above-described constitution is only an example, and the present disclosure is not limited to the above-described constitution. For example, it is possible to have a three-layer constitution in which an intermediate layer for improving close contact is provided between the first surface layer 52 and the second surface layer 53 or a constitution of four layers or more.

### Third Embodiment

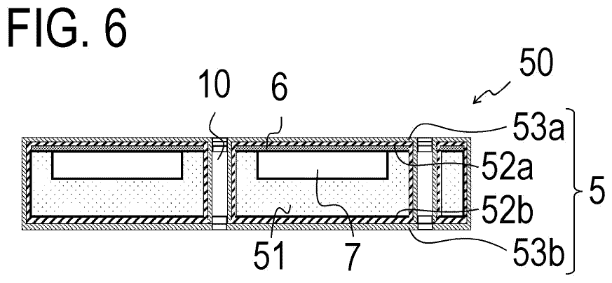

Subsequently, with reference to FIG. 6, the compliance substrate 50 according to a Third Embodiment will be explained. FIG. 6 is a schematic sectional diagram of the compliance substrate 50 according to the Third Embodiment. In the Third Embodiment, the surface member 5 is a laminated member constituted by a plurality of materials. In addition, the thickness of the surface member 5 is entirely uniform in the Second Embodiment, but in the Third Embodiment, the thickness of the surface member 5 is different between a part formed on the flexible member 6 side of the compliance substrate 50 and a part formed on the opposite side. Hereinafter, the part formed on the flexible member 6 side of the first surface layer 52 is assumed to be a first surface-layer upper part 52a, and the part formed on the side opposite to the flexible member 6 as a first surface-layer lower part 52b. Similarly, a part formed on the flexible member 6 side of the second surface layer 53 is assumed to be a second surface-layer upper part 53a, and a part formed on the side opposite to the flexible member 6 as a second surface-layer lower part 53b. That is, the first surface-layer upper part 52a is formed on the flexible member 6, and the first surface-layer lower part 52b is formed on the base substrate 51. Note that the upper part and the lower part here do not indicate an attitude in use of the liquid discharge head but up and down in FIG. 6 are used for convenience.

When the surface member 5 is formed by selecting the film-forming method with favorable deposition properties also on an inside of a three-dimensional structure such as the ALD method, the surface on the flexible member 6 side and the other surface of the compliance substrate 50 have the same degree of thickness as in the Second Embodiment. However, since the internal stress of the thin film is different depending on the base, if bases are formed by different materials for the front and the rear of the substrate, when the surface member 5 is formed with an entirely uniform thickness, a curve of the entire substrate might be changed. Thus, the surface member 5 according to the Third Embodiment has different layer thicknesses between the first surface-layer upper part 52a and the first surface-layer lower part 52b and is constituted such that the layer thickness is different between a second surface-layer upper part 53a and a second surface-layer lower part 53b. As described above, according to the constitution in which the thickness of the surface member 5 is made different between the flexible member 6 side and the opposite side thereof, a balance in the stress generated in each surface can be controlled. Thus, the curve of the entire compliance substrate 50 can be controlled, and the deterioration in the discharge controllability of the substrate 1 for liquid discharge head can be suppressed.

### Fourth Embodiment

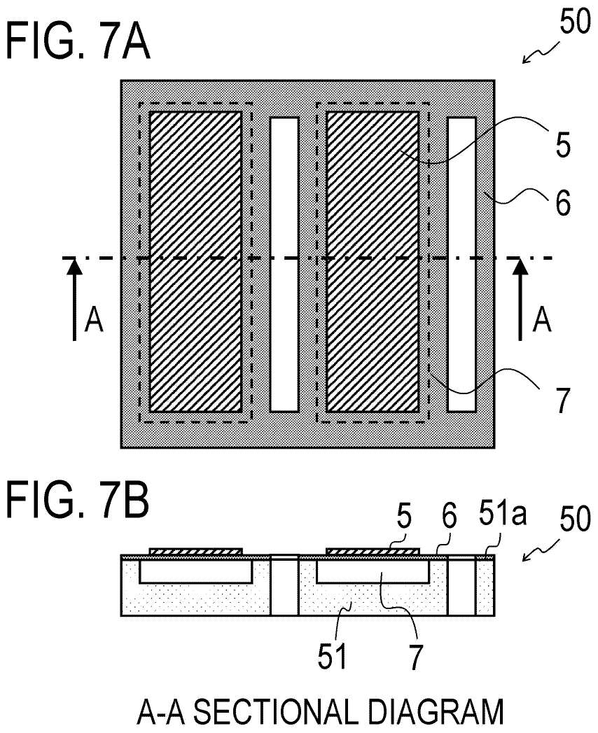

Subsequently, with reference to FIGS. 7A and 7B, the compliance substrate 50 according to a Fourth Embodiment will be explained. FIGS. 7A and 7B are explanatory diagrams of the compliance substrate 50 according to the Fourth Embodiment. FIG. 7A is a plan view of the compliance substrate 50 according to the Fourth Embodiment, which is a view of the compliance substrate 50 viewed in a laminating direction. Note that, the laminating direction is a laminating direction of the substrate 1 for liquid discharge head or the compliance substrate 50 and is a direction perpendicular to the adhesive surface 51a of the base substrate 51. FIG. 7B is an A-A sectional diagram of FIG. 7A and illustrates a schematic sectional diagram of the compliance substrate 50 according to the Fourth Embodiment. In the Fourth Embodiment, the surface member 5 is formed only at a part on the flexible member 6.

FIG. 7A illustrates an outer shape of the space 7 by a dotted line. In the Fourth Embodiment, when viewed in the laminating direction, one piece of the surface member 5 is formed by overlapping the space 7 so as to be contained in an inner side of one piece of the space 7. When viewed in the laminating direction, the surface member 5 is formed smaller than the space 7 and is not formed at a position overlapping the adhesive surface 51a of the base substrate 51. That is, in the Fourth Embodiment, the surface member 5 is formed only at a spot adjacent to the space 7 of the flexible member 6 in the laminating direction, which is a spot where warping is generated.

The surface member 5 does not have to be formed continuously in a series in a planar direction of the flexible member 6. One of merits when the surface members 5 are patterned in the planar direction and formed in plural discontinuously is that, if film peeling of the surface member 5 occurs at some spot, the film peeling would not occur in succession in the surroundings from that spot as a start point but can be retained to local film peeling. As shown in FIGS. 7A and 7B, by forming the surface member 5 only at a spot separating the space 7, which is a spot where the flexible member 6 is warped, and the liquid flow-passage 11, such effects can be obtained in both warping correction and prevention of expansion of the film peeling, and the deterioration of the discharge controllability of the substrate 1 for liquid discharge head can be suppressed.

### Fifth Embodiment

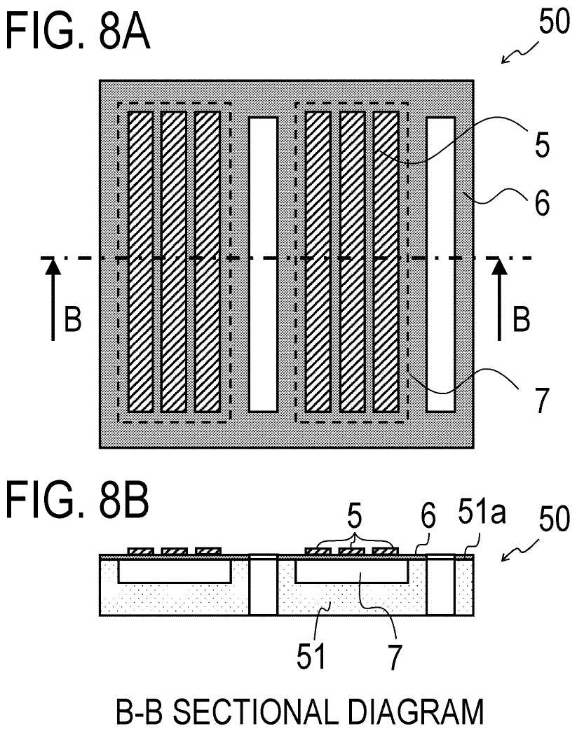

Subsequently, with reference to FIGS. 8A and 8B, the compliance substrate 50 according to a Fifth Embodiment will be explained. FIGS. 8A and 8B are explanatory diagrams of the compliance substrate 50 according to the Fifth Embodiment. FIG. 8A is a plan view of the compliance substrate 50 according to the Fifth Embodiment, which is a view of the compliance substrate 50 viewed in the laminating direction. FIG. 8B is a B-B sectional diagram of FIG. 8A and illustrates a schematic sectional diagram of the compliance substrate 50 according to the Fifth Embodiment. In the Fifth Embodiment, the surface member 5 is formed only at a part on the flexible member 6.

FIG. 8A illustrates an outer shape of the space 7 by a dotted line. In the Fifth Embodiment, when viewed in the laminating direction, three pieces of the surface members 5 are formed by overlapping the space 7 so as to be contained in the inner side of one piece of the space 7. That is, when viewed in the laminating direction, each of the surface members 5 is formed smaller than the space 7 and is not formed at a position overlapping the adhesive surface 51a of the base substrate 51. In addition, the three pieces of the surface members 5 are formed by aligning in a short-side direction orthogonal to a longitudinal direction of the space 7 at intervals from each other. That is, in the Fifth Embodiment, too, the surface member 5 is formed only at a spot adjacent to the space 7 of the flexible member 6 in the laminating direction, which is a spot where warping is generated.

As in the constitution of the Fifth Embodiment, by having a pattern in which the surface member 5 formed only at a warped part of the flexible member 6 is further divided in the planar direction, resistance against the film peeling is further improved. In addition, the suppression effect of the pressure fluctuation can be stably obtained even in the head drive for a long time, the deterioration in the discharge controllability of the substrate 1 for liquid discharge head can be suppressed for a long time.

### Sixth Embodiment

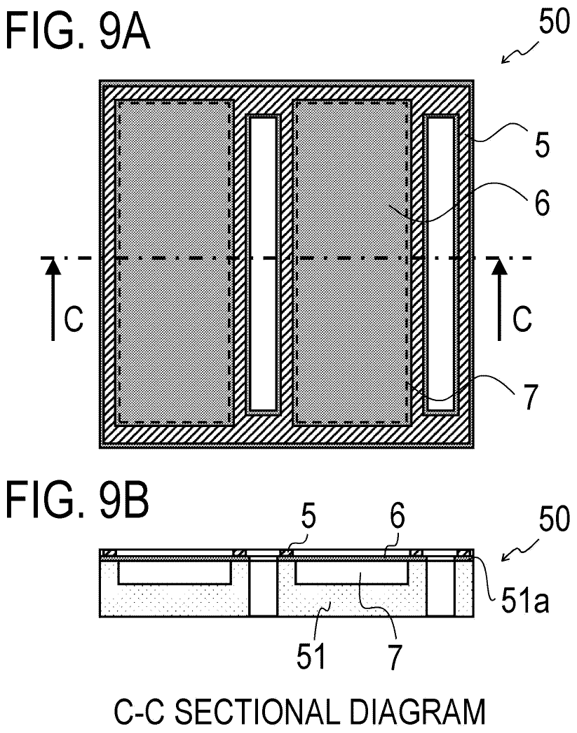

Subsequently, with reference to FIGS. 9A and 9B, the compliance substrate 50 according to a Sixth Embodiment will be explained. FIGS. 9A and 9B are explanatory diagrams of the compliance substrate 50 according to the Sixth Embodiment. FIG. 9A is a plan view of the compliance substrate 50 according to the Sixth Embodiment, which is a view of the compliance substrate 50 viewed in the laminating direction. FIG. 9B is a C-C sectional diagram of FIG. 9A and illustrates a schematic sectional diagram of the compliance substrate 50 according to the Sixth Embodiment. In the Sixth Embodiment, the surface member 5 is formed only at a part on the flexible member 6.

FIG. 9A illustrates an outer shape of the space 7 by a dotted line. In the Sixth Embodiment, when viewed in the laminating direction, the surface member 5 is formed at a position overlapping the adhesive surface 51a of the base substrate 51 and not overlapping the space 7 or the liquid supply port 10. That is, in the Sixth Embodiment, the surface member 5 is formed only at a spot adhering to the adhesive surface 51a of the flexible member 6, which is a spot where the flexible member 6 is not warped.

As in the constitution of the Sixth Embodiment, not by forming the surface member 5 at a spot where the flexible member 6 in contact with the space 7 is warped but by forming the surface member 5 in an area other than that, the warping can be also reduced indirectly. The constitution as above is preferable because such a concern is eliminated that the surface member 5 is not directly formed at an active part where the pressure fluctuation of the flexible member 6 is absorbed and thus, there is no more concern that the flexibility is hindered, and there is no concern of performance change caused by the film peeling, either. The reasons why the warping can be reduced by indirect film-forming of the surface member 5 are as follows. As already described, the warping emerges with the stress caused by a difference between heat expansion and contraction between the flexible member 6 and the base substrate 51 as a cause. The entire substrate is curved by the stress, while the flexible member 6 at a part tented in the space 7 (covering the space 7) is not supported by the base of the base substrate 51, it is warped at the spot and alleviates the stress. That is, the total stress is distributed to the curve and the warping of the substrate, and if the curve of the substrate can be made smaller, the warping can be also reduced as a result. Therefore, by the film-forming of the surface member 5 in the area other than the warping spot so as to reduce the curve of the substrate, the warping of the flexible member 6 can be indirectly reduced.

### Seventh Embodiment

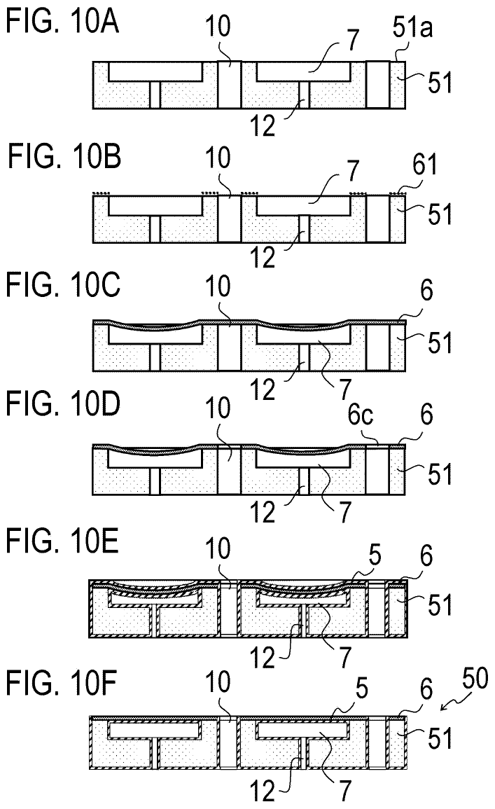

Subsequently, with reference to FIGS. 10A to 10F, the compliance substrate 50 according to a Seventh Embodiment will be explained. FIGS. 10A to 10F are explanatory diagrams of a manufacturing method of the compliance substrate 50 according to the Seventh Embodiment. In the Seventh Embodiment, the surface member 5 is formed on the surface on the space 7 side on the flexible member 6.

FIG. 10A illustrates the base substrate 51 in which an atmospheric communication port 12 connected to the space 7 is provided. The atmospheric communication port 12 penetrates from the space 7 to a surface on a side opposite to the adhesive surface 51a of the base substrate 51 to which the flexible member 6 is bonded. Since the atmospheric communication port 12 is provided, an internal pressure of the space 7 is opened to the atmospheric air. Therefore, the atmospheric communication port 12 is disposed for the purposes of improving productivity by solving a pressure difference inside and out of the space 7 in a manufacturing stage, of improving movability of the flexible member 6 and the like.

As shown in FIGS. 10B to 10D, after the flexible member 6 is joined to the base substrate 51 via the adhesive 61, the flexible member 6 is made to communicate with the liquid supply port 10 by dry etching or the like. FIG. 10B illustrates a state in which the adhesive 61 is applied on the base substrate 51. FIG. 10C illustrates a state in which the flexible member 6 is fixed onto the base substrate 51. FIG. 10D illustrates a state in which the opening portion 6c is formed in the flexible member 6. The manufacturing processes shown in these drawings are processes similar to FIGS. 4A to 4D according to the First Embodiment.

FIG. 10E illustrates a state in which the surface member 5 is formed on the surface of the flexible member 6. The surface member 5 can be formed by being deposited on the base substrate 51 by using the vapor growth methods such as the deposition method, the sputtering method, the CVD method and the like. At this time, the surface member 5 is deposited also on the surface on the space 7 side of the flexible member 6 through the atmospheric communication port 12. Preferably, deposition methods excellent in film-forming on a three-dimensional surface such as the ALD method, the Molecular Layer Deposition (MLD) method or the like can be used. According to the deposition methods as above, the surface member 5 can be uniformly deposited regardless of an opening size of the atmospheric communication port 12.

As shown in FIG. 10E, there can be a case in which the surface member 5 is deposited on the both surfaces of the flexible member 6 depending on the deposition method. In the Seventh Embodiment, the surface member 5 formed on the surface on the side opposite to the space 7 side and on the surface to be the liquid flow-passage 11 side is removed in the subsequent process. However, in application of the present disclosure, the surface member 5 formed on the surface on the space 7 side does not necessarily have to be removed. The surface member 5 deposited on the surface on the side opposite to the space 7 may remain deposited without being removed or may be in a state in which a part thereof is left in a film-thickness direction (laminating direction) or the planar direction without being removed at all, and it can be used as an adjustment margin for controlling an amount of warping.

By going through the processes as above, the surface member 5 as shown in FIG. 10F can be disposed on the surface on the space 7 side of the flexible member 6, and the compliance substrate 50 whose warping is suppressed can be obtained. In the Seventh Embodiment, as compared with the First Embodiment shown in FIGS. 4A to 4E, a disposition relation of the surface member 5 and the flexible member 6 is reversed. Therefore, in order to reduce the warping of the flexible member 6 generated in the manufacture, the size relation of the heat expansion coefficients of the surface member 5 and the flexible member 6 also need to be reversed. That is, the material is selected so that the heat expansion coefficient of the surface member 5 becomes larger than that of the flexible member 6. When an organic resin film with a low heat expansion property of approximately 10 ppm or less is used for the flexible member 6, for example, the warping of the flexible member 6 can be suppressed by using a metal thin film with the heat expansion coefficient of approximately several tens ppm, a high-molecular thin film with approximately several hundreds ppm or the like for the surface member 5.

### Eighth Embodiment

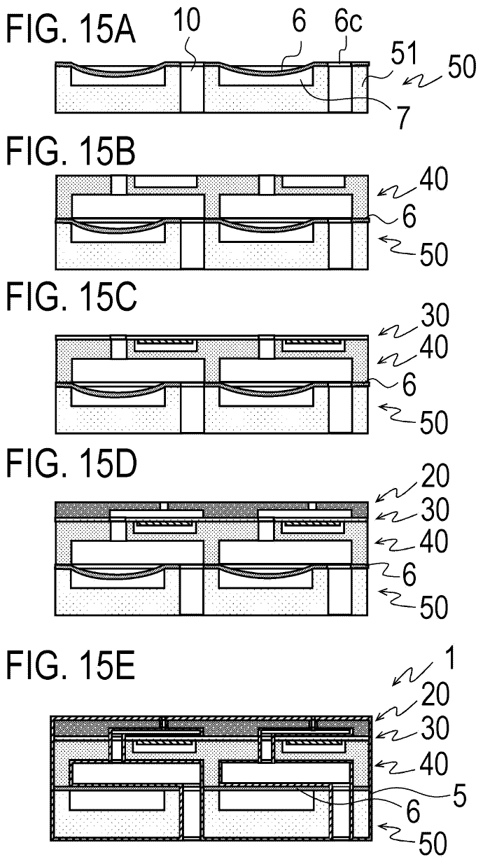

Subsequently, with reference to FIGS. 15A to 15E, the substrate 1 for liquid discharge head according to an Eighth Embodiment will be explained. FIGS. 15A to 15E are explanatory diagrams of a manufacturing method of the substrate 1 for liquid discharge head according to the Eighth Embodiment. In the Eighth Embodiment, the surface member 5 is formed continuously on the surface of the flexible member 6 and on the surface on the substrate 1 for liquid discharge head. Materials and a suitable thickness which can be applied to the surface member 5 are similar to those described in the paragraph of the First Embodiment.

FIGS. 15A to 15E illustrate the manufacturing method of the substrate 1 for liquid discharge head according to the Eighth Embodiment. FIG. 15A is a form similar to the compliance substrate 50 explained in the paragraph of the First Embodiment. FIG. 15B illustrates a state in which the flow-passage substrate 40 is formed on the compliance substrate 50. FIG. 15C illustrates a state in which the pressure-generation substrate 30 is further formed. FIG. 15D illustrates a state in which the nozzle substrate 20 is further formed.

The flow-passage substrate 40, the pressure-generation substrate 30, the nozzle substrate 20 are laminated in this order by joining, respectively. The joining can be performed regardless of the form of the substrate such as a wafer form, a chip form or the like, and the joining can be performed by a method of directly joining the substrate surfaces to each other, the joining via the adhesive layer such as a metal film, an organic resin, an inorganic film or the like. FIG. 15E illustrates the substrate 1 for liquid discharge head and a state in which the surface member 5 is formed on the surface of the flexible member 6. By forming the surface member 5 after the compliance substrate 50, the flow-passage substrate 40, the pressure-generation substrate 30, and the nozzle substrate 20 are joined, the surface member 5 is continuously formed on the surfaces of the flexible member 6 and the substrate 1 for liquid discharge head.

By using the manufacturing method as above, it becomes possible for the surface member 5 to cover the surface of the flexible member 6 and the entire surface of the nozzle 2, the pressure chamber 3, the liquid flow-passage (the individual supply port 8 and the common flow-passage 9) and the like constituting the substrate 1 for liquid discharge head, that is, the path of the liquid including the liquid flow-passages (the individual supply port 8 and the common flow-passage 9), the pressure chamber 3, and the nozzle 2 can be continuously covered in a lump-sum. As a result, all the parts in contact with the liquid including a joining interface between the substrates and the adhesive layer can be covered by the surface member 5, and protection against the liquid can be improved. By forming the surface member 5 for the entire substrate 1 for liquid discharge head as above, reduction in the warping of the flexible member 6 and the protection of the substrate 1 for liquid discharge head against the liquid can be performed at the same time, and a manufacturing cost can be reduced. A film-forming method of the surface member 5 in this case is not limited, but in the substrate 1 for liquid discharge head in which the liquid flow-passage, the nozzle, the pressure chamber and the like are disposed in a complicated manner, a method such as the ALD method, for example, which is excellent in conformal film-forming into an inside of a three-dimensional structure can be suitably used.

### Ninth Embodiment

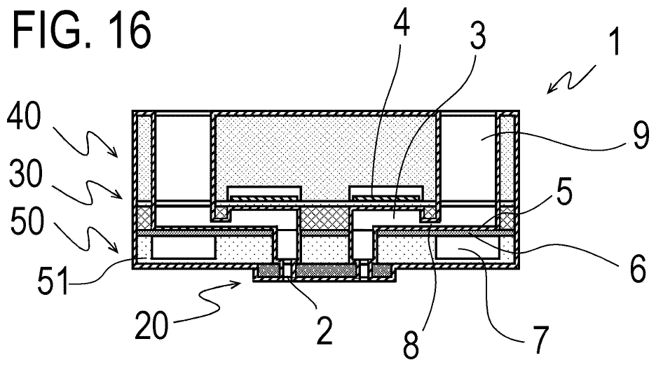

With reference to FIG. 16, a Ninth Embodiment will be explained. FIG. 16 is a schematic sectional diagram of a substrate for liquid discharge head according to the Ninth Embodiment. In the Ninth Embodiment, the base substrate 51 of the compliance substrate 50 is provided on the nozzle substrate 20 side with respect to the pressure-generation substrate 30. That is, the substrate 1 for liquid discharge head according to the Ninth Embodiment has the nozzle substrate 20, the compliance substrate 50, the pressure-generation substrate 30, the flow-passage substrate 40 in this order. Materials and suitable thickness that can be applied to the surface member 5 are similar to those described in the paragraph of the First Embodiment.

In this Embodiment, as an example, the flow-passage substrate 40 and the pressure-generation substrate 30 are formed of a silicon substrate, and the base substrate 51 is formed of stainless steel (SUS). The present disclosure can be suitably used even for the liquid discharge head using the substrate for liquid discharge head having the lamination configuration as in FIG. 16.

Subsequently, for some of the above-described Embodiments, the constitution of the substrate 1 for liquid discharge head, which was actually manufactured, and a discharge evaluation using the substrate 1 for liquid discharge head will be explained.

### Example 1

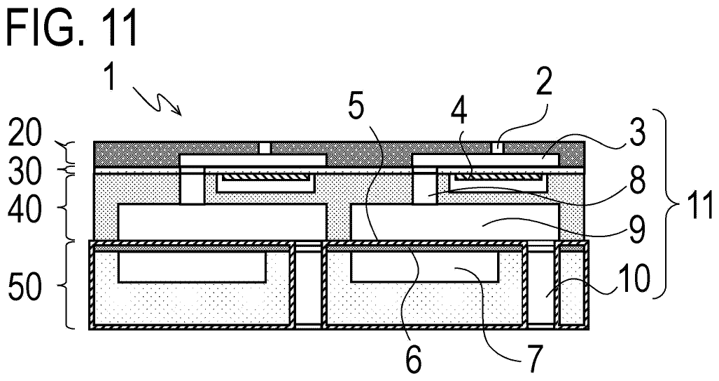

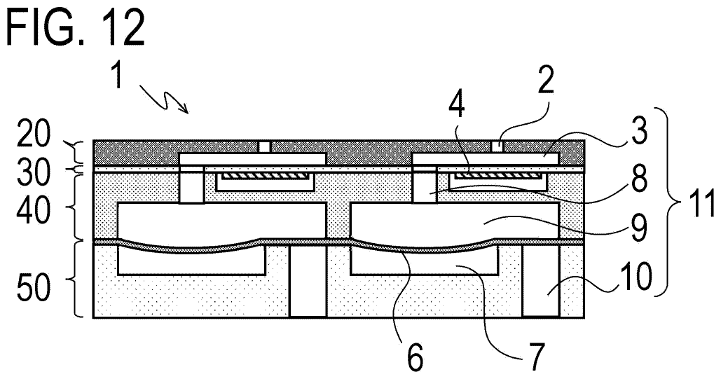

An Example 1 will be explained with reference to FIGS. 11 and 12. FIG. 11 is a schematic sectional diagram of the substrate 1 for liquid discharge head according to the Example 1. In the Example 1, similarly to the First Embodiment, the surface member 5 is provided on the entire surface on the liquid flow-passage 11 side of the flexible member 6. FIG. 12 is a schematic sectional diagram of the substrate 1 for liquid discharge head according to the Comparative Example. In the Comparative Example, the surface member 5 is not provided. The substrate 1 for liquid discharge head according to the Example 1 is constituted by the compliance substrate 50, the flow-passage substrate 40, the pressure-generation substrate 30, the nozzle substrate 20 aligned in this order.

In the Example 1, a silicon substrate was used for the base substrate 51 of the compliance substrate 50, a polyimide film was used as the flexible member 6, and a titanium oxide thin-film was used for the surface member 5. In the Example 1, the heat expansion coefficient of the base substrate 51, which is a silicon substrate, is approximately less than 5 ppm/K, and the heat expansion coefficient of the flexible member 6, which is a polyimide film, is approximately 10 to 50 ppm/K. In addition, the heat expansion coefficient of the surface member 5, which is a titanium oxide thin-film, is approximately 10 ppm/K.

In fabrication of the substrate 1 for liquid discharge head according to the Example 1, first, a resist pattern was drawn on the silicon substrate by the photolithography and then, the space 7 and the liquid supply port 10 were formed by performing the dry etching so as to fabricate the base substrate 51. Subsequently, an adhesive with an organic resin as a major component was applied to the adhesive surface 51a of the base substrate 51 in which the space 7 was formed, and the polyimide film with the thickness of 3 μm was bonded to the adhesive surface 51a. Subsequently, the heat treatment at 200° C. was performed so as to harden the adhesive, and the polyimide film was fixed to the base substrate 51. After the fixation, the polyimide film was warped to the space 7 side by approximately 2 μm.

After the polyimide film, which is the flexible member 6, was bonded to the base substrate 51, in order to remove the polyimide film on a part corresponding to the liquid supply port 10, pattern formation by the photoresist and the etching treatment were performed, and the liquid supply port 10 was made to penetrate. Subsequently, 100 nm of the titanium oxide thin-film was formed by the ALD method as the surface member 5, and the compliance substrate 50 was fabricated. In this state, the warping of the polyimide film toward the space 7 side was approximately 0.3 μm, which was reduced with respect to the warping of 2 μm after the fixation. The substrate 1 for liquid discharge head was fabricated by joining the compliance substrate 50 fabricated as above with the separately prepared nozzle substrate 20, the pressure-generation substrate 30, and the flow-passage substrate 40.

The manufacturing method of the substrate 1 for liquid discharge head according to the Comparative Example is similar to the Example 1 except the point that the surface member 5 is not formed. Therefore, as shown in FIG. 12, in the substrate 1 for liquid discharge head according to the Comparative Example, the surface member 5 is not formed on the surfaces of the flexible member 6 or the base substrate 51. And a warping amount of the flexible member 6 toward the space 7 side in the state where the pressure generator 4 in the Comparative Example is not generating a pressure is larger than that of the substrate 1 for liquid discharge head according to the Example 1.

The discharge evaluation was made by using the substrate 1 for liquid discharge head in the Example 1 fabricated as above and the substrate 1 for liquid discharge head in the Comparative Example. In the discharge evaluation, the liquid discharge was performed by using the respective substrates 1 for liquid discharge head, and the behaviors were observed. In the substrate 1 for liquid discharge head according to the Comparative Example, changes in a flying speed and a volume of the liquid considered to be a crosstalk occurred between the nozzles 2 adjacent to each other. On the other hand, in the substrate 1 for liquid discharge head according to the Example 1, the crosstalk did not occur under the same driving condition, and improvement in the suppression effect of the pressure fluctuation by the flexible member 6 was observed.

### Example 2

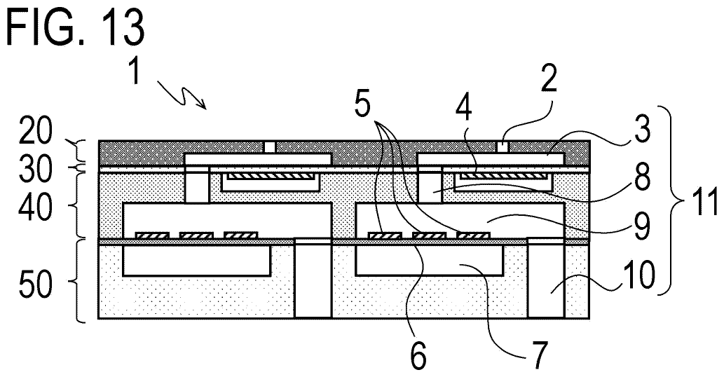

With reference to FIG. 13, an Example 2 will be explained. FIG. 13 is a schematic sectional diagram of the substrate 1 for liquid discharge head according to the Example 2. In the Example 2, similarly to the Fifth Embodiment, the surface member 5 is provided only at a part of the surface on the liquid flow-passage 11 side of the flexible member 6. And a plurality of the surface members 5 are provided adjacently in a direction parallel to the adhesive surface 51a (see FIG. 10A) of the base substrate 51 at intervals from each other.

In fabrication of the substrate 1 for liquid discharge head according to the Example 2, first, similarly to the Example 1, the compliance substrate 50 is fabricated. Subsequently, a dry film resist was bonded on a surface on the polyimide film side, a resist pattern was drawn by the photolithography and then, wet etching was performed so as to pattern a titanium oxide thin-film. The pattern was made a strip form, and the titanium oxide thin-film was formed within a region of the polyimide film at a position overlapping the space 7 when the compliance substrate 50 is viewed on a plan view. Through these processes, the titanium oxide thin-film is formed so that the plurality of surface members 5 are aligned at intervals in a direction parallel to the adhesive surface 51a of the base substrate 51. In this state, the warping of the polyimide film toward the space 7 side was approximately 0.5 μm, which was reduced with respect to the warping of 2 μm after the fixation.

The discharge evaluation was made similarly to the Example 1 by using the substrate 1 for liquid discharge head in the Example 2 fabricated as above. In the substrate 1 for liquid discharge head of the Example 2, too, a crosstalk did not occur similarly to the Example 1, and improvement in the suppression effect of the pressure fluctuation was observed. In addition, even in continuous discharge for a long time, discharge variation among the nozzles is small, and the effect of suppressing the film peeling of the titanium oxide thin-film, which is the surface member 5, can be obtained.

### Embodiment 3

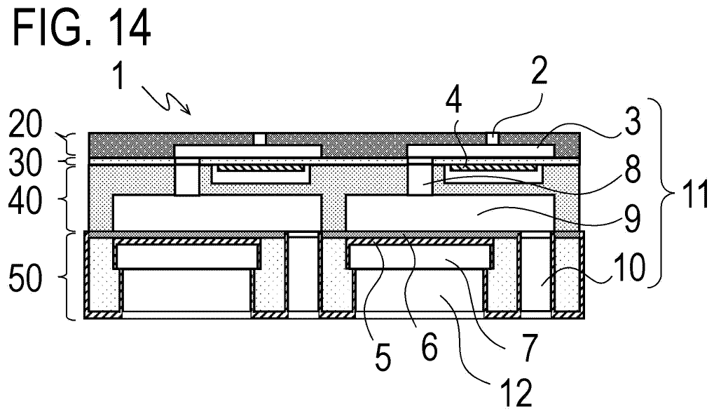

With reference to FIG. 14, an Example 3 will be explained. FIG. 14 is a schematic sectional diagram of the substrate 1 for liquid discharge head according to the Example 3. In the Example 3, similarly to the Seventh Embodiment, the surface member 5 is provided on the surface of the space 7 side of the flexible member 6.

In the Example 3, a silicon substrate was used for the base substrate 51 of the compliance substrate 50, a polyimide film was used as the flexible member 6, and a polyurethane resin was used for the surface member 5. In the Example 3, the heat expansion coefficient of the base substrate 51, which is a silicon substrate, is approximately less than 5 ppm/K, and the heat expansion coefficient of the flexible member 6, which is a polyimide film, is approximately 10 to 50 ppm/K. In addition, the heat expansion coefficient of the surface member 5, which is a titanium oxide thin-film, is approximately 100 to 200 ppm/K.

In the fabrication of the substrate 1 for liquid discharge head according to the Example 3, first, a resist pattern was drawn on the silicon substrate by the photolithography and then, dry etching was performed so as to form the space 7, the liquid supply port 10, and the atmospheric communication port 12, and the base substrate 51 was fabricated. Subsequently, on the adhesive surface 51a of the base substrate 51 on which the space 7 was formed, the adhesive with an organic resin as a major component was applied, and a polyimide film with a thickness of 3 μm was bonded on the adhesive surface 51a. Subsequently, the heat treatment at 200° C. was performed so as to harden the adhesive, and the polyimide film was fixed to the base substrate 51. After the fixation, the polyimide film was warped toward the space 7 side by approximately 1 μm.

After the polyimide film, which is the flexible member 6, was bonded to the base substrate 51, in order to remove the polyimide film on a part corresponding to the liquid supply port 10, the pattern formation by the photoresist and the etching treatment were performed, and the liquid supply port 10 was made to penetrate. Subsequently, the polyurethane resin was formed into a film of 1 μm on the surface of the space 7 side of the polyimide film from the atmospheric communication port 12 side by the vapor deposition polymerization method as the surface member 5 so as to fabricate the compliance substrate 50. In this state, the warping of the polyimide film toward the space 7 side was approximately 0.2 μm, which was reduced with respect to the warping of 1 μm after the fixation.

The discharge evaluation was made similarly to the Example 1 by using the substrate 1 for liquid discharge head in the Example 3 fabricated as above. In the substrate 1 for liquid discharge head according to the Example 3, too, a crosstalk did not occur as in the Example 1, and the effect to suppress the pressure fluctuation was improved.

### Example 4

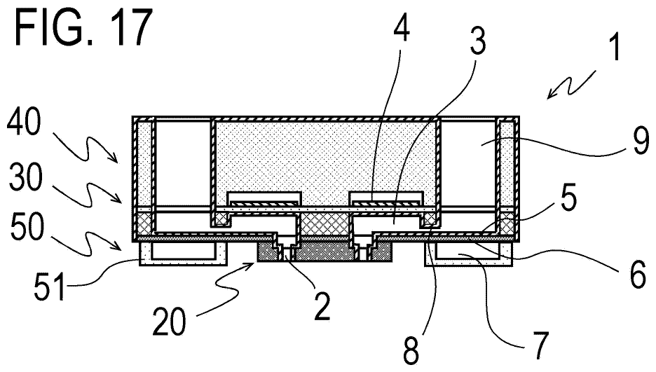

With reference to FIG. 17, an Example 4 will be explained. FIG. 17 is a schematic sectional diagram of the substrate 1 for liquid discharge head according to the Example 4. In the Example 4, similarly to the Eighth Embodiment, the surface member 5 is formed so as to continuously cover the surface of the substrate 1 for liquid discharge head including the surface of the flexible member 6 and the inner wall surface of the flow passage.

In the Example 4, the space 7 is formed on the side of a surface on which the nozzle 2 is formed in the substrate 1 for liquid discharge head, and a positional relation with the flexible member 6 in a sectional direction of the substrate 1 for liquid discharge head is configured to be different from the Examples 1 to 3. In addition, the substrate 1 for liquid discharge head according to the Example 4 is constituted by the nozzle substrate 20, the compliance substrate 50, the pressure-generation substrate 30, and the flow-passage substrate 40 aligned in this order.

In the fabrication of the substrate 1 for liquid discharge head according to the Example 4, first, the base substrate 51 was fabricated similarly to the Example 1, the flexible member 6 such as a polyimide film was bonded and then, patterning was performed. As a result, the compliance substrate 50 before film formation of the surface member 5 is performed was fabricated. Subsequently, the pressure-generation substrate 30, the flow-passage substrate 40, and the nozzle substrate 20 prepared separately were joined sequentially so as to form the substrate 1 for liquid discharge head before the film formation of the surface member 5. Lastly, by film formation of the surface member 5, the substrate 1 for liquid discharge head having the schematic sectional diagram shown in FIG. 17 was fabricated.

The discharge evaluation was made similarly to the Example 1 by using the substrate 1 for liquid discharge head in the Example 4 fabricated as above. In the substrate 1 for liquid discharge head according to the Example 4, too, a crosstalk did not occur as in the Example 1, and the effect to suppress the pressure fluctuation was improved. In addition, the substrate 1 for liquid discharge head was immersed in a liquid, and a heat-cycle test (0.15 MPa, 120° C., 30 cycles) was executed under pressurization, but peeling of the substrate or large dissolution inside the flow passage was not confirmed, but it was found out that an effect of improving protection of the surface member 5 continuously wrapping the substrate 1 for liquid discharge head was high.

Note that, each of the above-described Embodiments has a configuration on the premise that the flexible member 6 is warped toward the space 7 side, but the present disclosure can be applied also to such a configuration that the flexible member 6 is warped toward the liquid flow-passage 11 side. For example, when an inorganic film or a metal film with a heat expansion coefficient smaller than that of the organic resin is used for the flexible member 6, and an amorphous substrate such as an organic resin substrate, a glass substrate or the like with a large heat expansion coefficient is used for the base substrate 51, the heat expansion coefficient of the flexible member 6 can be smaller than that of the base substrate 51. When the heat expansion coefficient of the flexible member 6 is smaller than that of the base substrate 51, there is a possibility that the flexible member 6 is warped toward the liquid flow-passage 11 side after the heat treatment of the adhesive 61. In such cases, the surface member 5 with the heat expansion coefficient larger than that of the flexible member 6 is provided on the surface on the liquid flow-passage 11 side of the flexible member 6, or the surface member 5 with the heat expansion coefficient smaller than that of the flexible member 6 is provided on the surface on the space 7 side of the flexible member 6 so that the warping of the flexible member 6 can be reduced.

In addition, the configuration of each of the Embodiments described above can be combined as appropriate. For example, as in the First Embodiment, a plurality of the surface members 5 may be aligned and formed as in the Fourth Embodiment or the Fifth Embodiment on the whole surface on the liquid flow-passage 11 side of the flexible member 6. In addition, for example, as in the Second Embodiment or the Third Embodiment, the surface member 5 constituted by a plurality of layers may be formed on the surface on the space 7 side of the flexible member 6 as in the Seventh Embodiment.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-210990, filed on Dec. 14, 2023 and Japanese Patent Application No. 2024-167211, filed on Sep. 26, 2024, which are hereby incorporated by reference herein in their entirety.

What is claimed is:

1. A liquid discharge head comprising:
a nozzle from which a liquid is discharged;
pressure generator that generates a pressure for discharging the liquid from the nozzle;
a pressure chamber in which the pressure generator is formed inside;
a liquid flow-passage that communicates with the nozzle;
a space formed adjacently to the liquid flow-passage and separated from the liquid flow-passage;
a base body constituting a wall part forming the liquid flow-passage and a wall part constituting the space; and
a flexible member made of a resin, fixed to the base body, and separating the liquid flow-passage and the space, the flexible member being warped in accordance with pressure fluctuation generated in the pressure chamber, and an inorganic film being provided on a surface of the flexible member.

2. The liquid discharge head according to claim 1,
wherein the inorganic film is constituted such that warping of the flexible member in a state in which the pressure generator is not generating a pressure is reduced.

3. The liquid discharge head according to claim 1,
wherein the inorganic film is formed on a surface facing the liquid flow-passage side of the flexible member.

4. The liquid discharge head according to claim 3,
wherein a heat expansion coefficient of the flexible member is larger than the heat expansion coefficient of the base body, and the heat expansion coefficient of the inorganic film is smaller than the heat expansion coefficient of the flexible member.

5. The liquid discharge head according to claim 1,
wherein the inorganic film is formed on a surface facing the space side of the flexible member.

6. The liquid discharge head according to claim 5,
wherein the heat expansion coefficient of the flexible member is smaller than the heat expansion coefficient of the base body, and the heat expansion coefficient of the inorganic film is larger than the heat expansion coefficient of the flexible member.

7. The liquid discharge head according to claim 1,
wherein a thickness of the inorganic film is smaller than the thickness of the flexible member.

8. The liquid discharge head according to claim 1,
wherein, in a case where the flexible member is viewed in a direction perpendicular to a fixing surface to which the flexible member of the base body is fixed, the flexible member is provided at a position that overlaps the space and does not overlap the fixing surface.

9. The liquid discharge head according to claim 8,
wherein a plurality of the flexible members are disposed adjacently in a direction parallel to the fixing surface at intervals from each other.

10. The liquid discharge head according to claim 1,
wherein, in a case where the flexible member is viewed in a direction perpendicular to a fixing surface to which the flexible member of the substrate is fixed, the flexible member is provided at a position that overlaps the fixing surface and does not overlap the space.

11. The liquid discharge head according to claim 1,
wherein the inorganic film includes at least one of titanium oxide, tantalum oxide, and silicon carbide.

12. The liquid discharge head according to claim 1,
wherein the inorganic film has a first surface layer adjacent to the space, and a second surface layer including a component different from the first surface layer and adjacent to the liquid flow-passage.

13. The liquid discharge head according to claim 12,
wherein the first surface layer includes tantalum oxide, and the second surface layer includes silicon carbide.

14. The liquid discharge head according to claim 1,
wherein the inorganic film is provided also on a surface on a side opposite to a fixing surface to which the flexible member of the base body is fixed.

15. The liquid discharge head according to claim 1,
wherein the base body is formed of a silicon substrate.

16. The liquid discharge head according to claim 1,
wherein the liquid discharge head has a nozzle substrate including the nozzle, a pressure chamber substrate including the pressure chamber, and a flow-passage substrate including the liquid flow-passage communicating with the pressure chamber in this order, and
the inorganic film is provided such that a liquid path including the liquid flow-passage, the pressure chamber, and the nozzle are continuously covered.

17. A manufacturing method of a liquid discharge head, the liquid discharge head including a nozzle from which a liquid is discharged, pressure generator that generates a pressure for discharging the liquid from the nozzle, a pressure chamber in which the pressure generator is formed inside, a liquid flow-passage communicating with the nozzle, a space formed adjacently to the liquid flow-passage and separated from the liquid flow-passage, a base body constituting a wall part forming the liquid flow-passage and a wall part forming the space, a flexible member made of a resin, which is fixed to the base body, separates the liquid flow-passage and the space from each other and is warped in accordance with pressure fluctuation generated in the pressure chamber, and an inorganic film provided on a surface of the flexible member, the manufacturing method comprising:
a process of applying an adhesive on a surface of the base body;
a process of bonding the flexible member on the surface of the base body on which the adhesive was applied;
a process of executing heat treatment and hardening the adhesive; and
a process of forming the inorganic film on the surface of the flexible member.

18. The manufacturing method of a liquid discharge head according to claim 17,
wherein the inorganic film is formed such that the inorganic film covers exposed surfaces of the base body and the flexible member.

19. The manufacturing method of a liquid discharge head according to claim 17,
wherein the heat expansion coefficient of the flexible member is larger than the heat expansion coefficient of the base body, and the heat expansion coefficient of the inorganic film is smaller than the heat expansion coefficient of the flexible member; and
wherein the inorganic film is formed on a surface on a side opposite to a fixed surface fixed to the base body of the flexible member.

20. The manufacturing method of a liquid discharge head according to claim 17,
wherein, in the process of forming the inorganic film on the surface of the flexible member, the inorganic film is formed also at least on a surface of one of the nozzle, the liquid flow-passage, the pressure chamber, and the pressure generator at the same time.
